(19) United States
(12) Patent Application Publication
(10) Pub. No.: US 2026/0210998 A1
(43) Pub. Date: Jul. 23, 2026

(54) Sensor Module

(71) Applicant: SEIKO EPSON CORPORATION, Tokyo (JP)

(72) Inventors: Fumikazu OTANI, Azumino (JP); Shinichi MITSUNAGA, Shiojiri (JP)

(21) Appl. No.: 19/456,548

(22) Filed: Jan. 22, 2026

(30) Foreign Application Priority Data
Jan. 23, 2025 (JP) 2025-009886

(51) Int. Cl. G01P 15/08; G01P 3/44; G01P 15/18

(52) U.S. Cl. CPC G01P 15/08; G01P 3/44; G01P 15/18; G01P 2015/0865

(57) ABSTRACT

A sensor module includes: a sensor device; a first timer that counts a first time which is a time of one cycle of a trigger signal input from an outside; a trigger processing portion that determines a second time shorter than the first time based on a count value of the first time counted by the first timer, and generates a timing signal each time the second time elapses in synchronization with the trigger signal; and a sampling processing portion that performs arithmetic processing by sampling a signal output from the sensor device in synchronization with the timing signal.

The present application is based on, and claims priority from JP Application Serial Number 2025-009886, filed January 23, 2025, the disclosure of which is hereby incorporated by reference herein in its entirety.

### BACKGROUND

### 1. Technical Field

The present disclosure relates to a sensor module.

### 2. Related Art

JP-A-2015-76805 discloses a synchronization control system including an inertial measurement device and a host computer, in which the host computer transmits a synchronization trigger signal to the inertial measurement device, calculates a sampling time point of six-axis sensor data based on a transmission time point of the synchronization trigger signal, and synchronizes the sampling time point of the six-axis sensor data with time point information of the host computer.

However, in the synchronization control system described in JP-A-2015-76805, data is output at a cycle of the synchronization trigger signal of the inertial measurement device, and the cycle of the data output cannot be made shorter than the cycle of the synchronization trigger signal.

### SUMMARY

According to an aspect of the present disclosure, there is provided a sensor module including: a sensor device; a first timer that counts a first time which is a time of one cycle of a trigger signal input from an outside; a trigger processing portion that determines a second time shorter than the first time based on a count value of the first time counted by the first timer, and generates a timing signal each time the second time elapses in synchronization with the trigger signal; and a sampling processing portion that performs arithmetic processing by sampling a signal output from the sensor device in synchronization with the timing signal.

### BRIEF DESCRIPTION OF THE DRAWINGS

FIG. 1 is a diagram illustrating a configuration of a sensor module of a first embodiment.

FIG. 2 is a diagram illustrating a configuration example of an angular velocity sensor.

FIG. 3 is a diagram illustrating a configuration example of a 6DoF sensor.

FIG. 4 is a timing chart diagram illustrating an example of an operation of the sensor module of the first embodiment.

FIG. 5 is a timing chart diagram illustrating an example of an operation of the sensor module of the first embodiment.

FIG. 6 is a diagram illustrating a calculation example of timeout values of a second timer.

FIG. 7 is a diagram illustrating a series example of timeout values of the second timer.

FIG. 8 is a diagram illustrating a configuration of a sensor module of a second embodiment.

FIG. 9 is a diagram illustrating a calculation example of count values of a first timer that ends a second time.

FIG. 10 is a diagram illustrating a series example of timeout values of the first timer that ends the second time.

FIG. 11 is a diagram illustrating an example of a composite navigation system in which the sensor module is incorporated.

### DESCRIPTION OF EMBODIMENTS

Hereinafter, appropriate embodiments of the present disclosure will be described in detail with reference to the drawings. The following embodiment does not inappropriately limit the contents of the present disclosure described in the claims. In addition, not all of the configurations which will be described below are necessarily essential components of the present disclosure.

### 1. First Embodiment

### 1-1. Configuration of Sensor Module

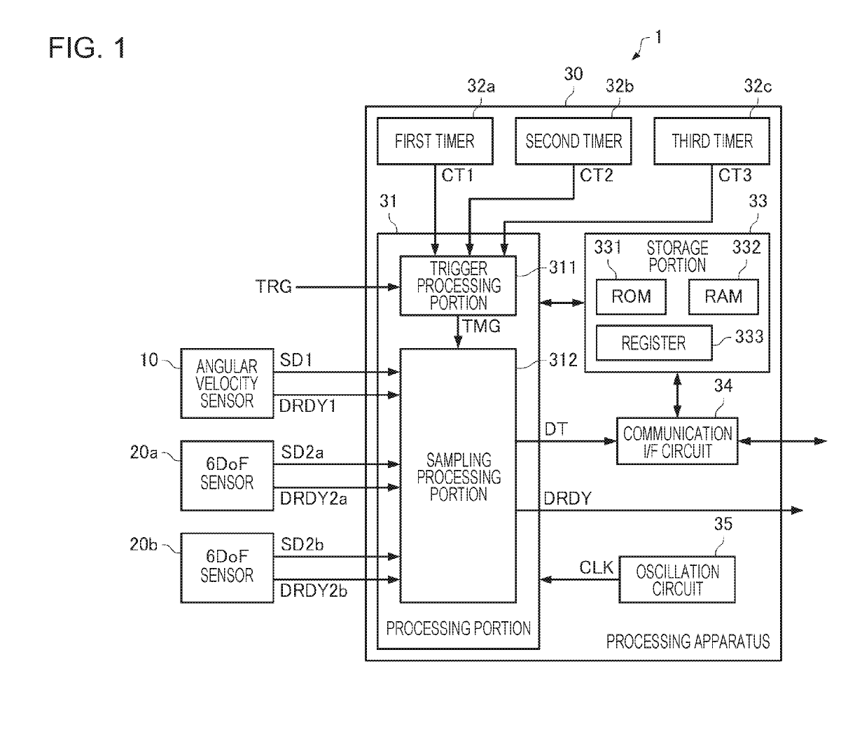

FIG. 1 is a diagram illustrating a configuration of a sensor module of a first embodiment. As illustrated in FIG. 1, a sensor module 1 of the first embodiment includes an angular velocity sensor 10, 6DoF sensors 20a and 20b, and a processing apparatus 30. The sensor module 1 is mounted on a moving object such as an automobile, and the X axis, the Y axis, and the Z axis, which are orthogonal to each other, are defined. For example, the sensor module 1 is mounted on the moving object such that the X axis faces the traveling direction of the moving object, the Y axis faces the lateral direction of the moving object, and the Z axis faces the downward direction of the moving object.

The angular velocity sensor 10 is a sensor device that detects an angular velocity. The detection axis of the angular velocity sensor 10 is mounted on the sensor module 1, for example, to be along the Z axis. That is, the angular velocity sensor 10 detects the angular velocity around the Z axis.

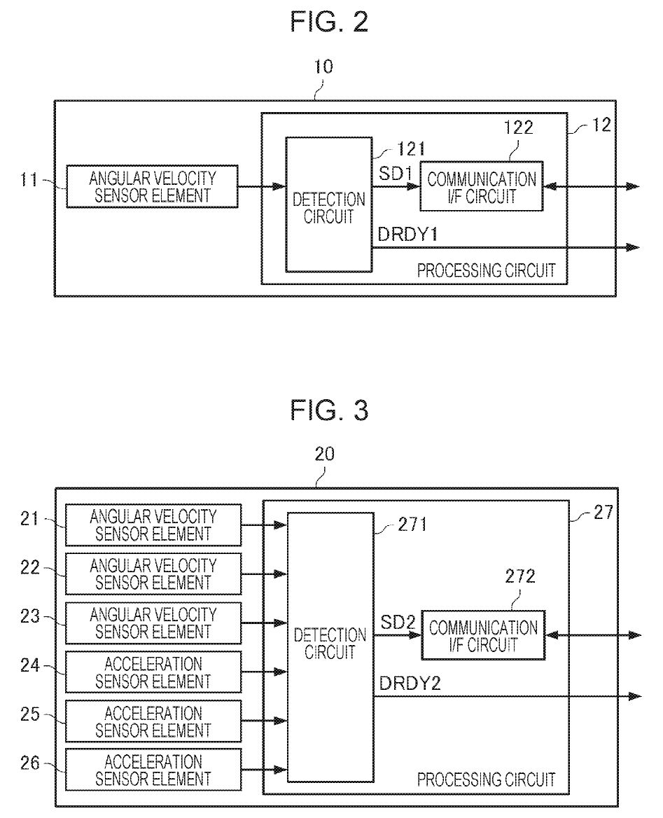

FIG. 2 is a diagram illustrating a configuration example of the angular velocity sensor 10. As illustrated in FIG. 2, the angular velocity sensor 10 includes an angular velocity sensor element 11 and a processing circuit 12. For example, the angular velocity sensor 10 may be a device in which a print substrate on which the angular velocity sensor element 11 and the processing circuit 12 are mounted is accommodated in a package. The processing circuit 12 may be, for example, an IC chip realized by a semiconductor. The IC is an abbreviation for Integrated Circuit.

The angular velocity sensor element 11 is, for example, an element made of quartz and detects an angular velocity around the Z axis.

The processing circuit 12 performs angular velocity detection processing on the signal output from the angular velocity sensor element 11, and outputs a detection signal SD1 obtained by the detection processing. The processing circuit 12 includes a detection circuit 121 that performs angular velocity detection processing on a signal output from the angular velocity sensor element 11, and an interface circuit 122 that outputs the detection signal SD1 obtained by the detection processing of the detection circuit 121.

The detection circuit 121 acquires the signal output from the angular velocity sensor element 11 at a predetermined cycle, performs predetermined arithmetic processing, and generates the detection signal SD1. In addition, the detection circuit 121 generates a data ready signal DRDY1 for notifying that the detection signal SD1 is prepared each time the generation of the detection signal SD1 is completed. The detection signal SD1 is output to the interface circuit 122, and the data ready signal DRDY1 is output to the processing apparatus 30.

The interface circuit 122 acquires the detection signal SD1 output from the detection circuit 121 in accordance with a read command input from the processing apparatus 30, and outputs the acquired detection signal SD1 to the processing apparatus 30.

Returning to the description of FIG. 1, the 6DoF sensors 20a and 20b are sensor devices that detect 3-axis angular velocity and 3-axis acceleration, respectively. The 6DoF sensors 20a and 20b are mounted on the sensor module 1 such that the three detection axes are along the X axis, the Y axis, and the Z axis, respectively. That is, the 6DoF sensors 20a and 20b detect the angular velocity around the X axis, the angular velocity around the Y axis, the angular velocity around the Z axis, the acceleration in the X axis direction, the acceleration in the Y axis direction, and the acceleration in the Z axis direction. The 6DoF sensors 20a and 20b have the same configuration, and hereinafter, when it is not necessary to distinguish the 6DoF sensors 20a and 20b, the 6DoF sensors 20a and 20b are referred to as a “6DoF sensor 20”. Further, in a case of distinguishing the 6DoF sensors 20a and 20b, “a” or “b” is added to the various names.

FIG. 3 is a diagram illustrating a configuration example of the 6DoF sensor 20. As illustrated in FIG. 3, the 6DoF sensor 20 includes angular velocity sensor elements 21, 22, and 23, acceleration sensor elements 24, 25, and 26, and a processing circuit 27. For example, the 6DoF sensor 20 may be a silicon MEMS sensor in which a silicon substrate on which the angular velocity sensor elements 21, 22, and 23, the acceleration sensor elements 24, 25, and 26, and the processing circuit 27 are formed is accommodated in a package. The MEMS is an abbreviation for Micro Electro Mechanical Systems.

The angular velocity sensor element 21 is an element that detects an angular velocity around the X axis. The angular velocity sensor element 22 is an element that detects an angular velocity around the Y axis. The angular velocity sensor element 23 is an element that detects an angular velocity around the Z axis.

The acceleration sensor element 24 is an element that detects an acceleration in the X axis direction. The acceleration sensor element 25 is an element that detects an acceleration in the Y axis direction. The acceleration sensor element 26 is an element that detects acceleration in the Z axis direction.

The processing circuit 27 performs angular velocity detection processing on signals output from the angular velocity sensor elements 21, 22, and 23, respectively, performs acceleration detection processing on signals output from the acceleration sensor elements 24, 25, and 26, respectively, and outputs a detection signal SD2 obtained by these detection processing. The processing circuit 27 includes: a detection circuit 271 that performs angular velocity detection processing on signals output from the angular velocity sensor elements 21, 22, and 23, respectively, and performs acceleration detection processing on signals output from the acceleration sensor elements 24, 25, and 26, respectively; and an interface circuit 272 that outputs the detection signal SD2 obtained by the detection processing of the detection circuit 271.

The detection circuit 271 acquires signals output from the angular velocity sensor elements 21, 22, and 23 and the acceleration sensor elements 24, 25, and 26, respectively, at a predetermined cycle, performs predetermined arithmetic processing, and generates the detection signal SD2. The detection signal SD2 includes an X-axis angular velocity detection signal obtained based on an output signal of the angular velocity sensor element 21, a Y-axis angular velocity detection signal obtained based on an output signal of the angular velocity sensor element 22, and a Z-axis angular velocity detection signal obtained based on an output signal of the angular velocity sensor element 23. Further, the detection signal SD2 includes an X-axis acceleration detection signal obtained based on the output signal of the acceleration sensor element 24, a Y-axis acceleration detection signal obtained based on the output signal of the acceleration sensor element 25, and a Z-axis acceleration detection signal obtained based on the output signal of the acceleration sensor element 26. Further, the detection circuit 271 generates a data ready signal DRDY2 for notifying that the detection signal SD2 is prepared each time the generation of the detection signal SD2 is completed. The detection signal SD2 is output to the interface circuit 272, and the data ready signal DRDY2 is output to the processing apparatus 30.

The interface circuit 272 acquires the detection signal SD2 output from the detection circuit 271 in accordance with the read command input from the processing apparatus 30, and outputs the acquired detection signal SD2 to the processing apparatus 30.

Returning to the description of FIG. 1, the processing apparatus 30 communicates with the angular velocity sensor 10 and the 6DoF sensors 20a and 20b, and acquires the detection signals SD1, SD2a, and SD2b. The processing apparatus 30 is a master controller for the angular velocity sensor 10 and the 6DoF sensors 20a and 20b. The communication between the processing apparatus 30 and the angular velocity sensor 10 and the 6DoF sensors 20a and 20b may be performed in accordance with a communication standard such as SPI or I2C, or may be performed in accordance with a communication standard developed from any of these communication standards or a communication standard in which a part is improved or modified. SPI is an abbreviation for Serial Peripheral Interface. I2C is an abbreviation for Inter-Integrated Circuit.

The processing apparatus 30 is realized by a processor such as an MCU. The MCU is an abbreviation for Micro Controller Unit. Alternatively, the processing apparatus 30 may be realized by an ASIC using automatic arrangement wiring such as a gate array. ASIC is an abbreviation for Application Specific Integrated Circuit.

The processing apparatus 30 samples the detection signal SD1 output from the angular velocity sensor 10, the detection signal SD2a output from the 6DoF sensor 20a, and the detection signal SD2b output from the 6DoF sensor 20b, and outputs measurement data DT based on the detection signals SD1, SD2a, and SD2b. Specifically, when the data ready signal DRDY1 is input from the angular velocity sensor 10, the processing apparatus 30 outputs a read command for the detection signal SD1 to the angular velocity sensor 10 to read the detection signal SD1, and thus samples the detection signal SD1. Further, when a data ready signal DRDY2a is input from the 6DoF sensor 20a, the processing apparatus 30 outputs a read command for the detection signal SD2a to the 6DoF sensor 20a to read the detection signal SD2a, and thus samples the detection signal SD2a. Further, when the data ready signal DRDY2b is input from the 6DoF sensor 20b, the processing apparatus 30 outputs a read command for the detection signal SD2b to the 6DoF sensor 20b to read the detection signal SD2b, and thus samples the detection signal SD2b.

The communication between the processing apparatus 30 and the angular velocity sensor 10 and the 6DoF sensors 20a and 20b may be performed in accordance with a communication standard of UART. UART is an abbreviation for Universal Asynchronous Receiver Transmitter. In this case, the processing apparatus 30 samples the detection signal SD1 output from the angular velocity sensor 10 in synchronization with the data ready signal DRDY1. Further, the processing apparatus 30 samples the detection signal SD2a output from the 6DoF sensor 20a in synchronization with the data ready signal DRDY2a. Further, the processing apparatus 30 samples the detection signal SD2b output from the 6DoF sensor 20b in synchronization with the data ready signal DRDY2b.

As illustrated in FIG. 1, the processing apparatus 30 includes a processing portion 31, a first timer 32a, a second timer 32b, a third timer 32c, a storage portion 33, a communication interface circuit 34, and an oscillation circuit 35.

The oscillation circuit 35 outputs a clock signal CLK. The oscillation circuit 35 may be, for example, a crystal oscillation circuit or may be an LC oscillation circuit. The frequency of the clock signal CLK is, for example, several MHz, and the clock signal CLK is supplied to each portion of the processing apparatus 30.

The storage portion 33 includes a ROM 331, a RAM 332, and a register 333. ROM is an abbreviation for Read Only Memory, and RAM is an abbreviation for Random Access Memory. The ROM 331 stores various programs and predetermined data. The RAM 332 is used as a work area of the processing portion 31, and stores a program or data read from the ROM 331, and data temporarily generated by the processing portion 31. The register 333 stores various setting data of the processing portion 31, various flag data generated by the processing portion 31, and the like.

The first timer 32a counts a first time T1, which is the time of one cycle of a trigger signal TRG input from the outside of the sensor module 1. Specifically, the first timer 32a repeats an operation of counting the number of pulses of the clock signal CLK included in the period of one cycle of the trigger signal TRG in synchronization with the trigger signal TRG and outputting a count value CT1. The frequency of the trigger signal TRG is, for example, in the range of 1 Hz to 1 kHz, and the first time T1 is in the range of 1 millisecond to 1 second. The count value CT1 of the first timer 32a is output to the processing portion 31.

The second timer 32b repeatedly counts a second time T2 shorter than the first time T1 in synchronization with the trigger signal TRG. Specifically, the second timer 32b starts counting the number of pulses of the clock signal CLK in synchronization with the trigger signal TRG. The second timer 32b resets the count value CT2 each time the count value CT2 matches the timeout value corresponding to the count value of the second time T2, and repeats the counting of the second time T2. The timeout value of the second timer 32b is set in the register 333 in advance. The second time T2 is a time corresponding to a sampling cycle of the sampling processing portion 312, which will be described later. The count value CT2 of the second timer 32b is output to the processing portion 31.

The third timer 32c counts a third time T3 shorter than the second time T2 in synchronization with a timing signal TMG generated by the trigger processing portion 311, which will be described later. Specifically, the third timer 32c starts counting the third time T3 at the same timing as the start of the counting of the second time T2 by the second timer 32b. The third timer 32c resets a count value CT3 each time the count value CT3 matches the timeout value corresponding to the count value of the third time T3, and then repeats the operation of starting the counting of the third time T3 at the timing when the second timer 32b starts the counting of the second time T2. The timeout value of the third timer 32c is set in the register 333 in advance. The third time T3 corresponds to the time from when the sampling processing portion 312, which will be described later, starts the sampling processing until the data ready signal DRDY is output. The count value CT3 of the third timer 32c is output to the processing portion 31.

The processing portion 31 performs various arithmetic processing on the detection signals SD1, SD2a, and SD2b in synchronization with the clock signal CLK to generate the measurement data DT. The processing portion 31 performs various controls on the first timer 32a, the second timer 32b, the third timer 32c, the storage portion 33, and the communication interface circuit 34.

The processing portion 31 includes the trigger processing portion 311 and the sampling processing portion 312. The processing portion 31 may function as the trigger processing portion 311 and the sampling processing portion 312 by executing a program (not illustrated) stored in the ROM 331. Alternatively, the trigger processing portion 311 and the sampling processing portion 312 may be realized by hardware.

The trigger processing portion 311 determines the second time T2 based on the count value CT1 of the first time T1 counted by the first timer 32a, and generates the timing signal TMG each time the second time T2 elapses in synchronization with the trigger signal TRG. Specifically, the trigger processing portion 311 generates the timing signal TMG each time the second timer 32b counts the second time T2, and outputs the timing signal TMG to the sampling processing portion 312.

The sampling processing portion 312 performs the arithmetic processing by sampling the detection signal SD1 output from the angular velocity sensor 10, the detection signal SD2a output from the 6DoF sensor 20a, and the detection signal SD2b output from the 6DoF sensor 20b in synchronization with the timing signal TMG generated by the trigger processing portion 311. That is, the sampling processing portion 312 performs the arithmetic processing by sampling the detection signals SD1, SD2a, and SD2b at the cycle of the timing signal TMG. In the following, a case where the sampling processing portion 312 performs the arithmetic processing by sampling the detection signals SD1, SD2a, and SD2b may be referred to as “sampling processing”.

The sampling processing portion 312 performs various arithmetic processing on the detection signals SD1, SD2a, and SD2b, and generates the measurement data DT. Here, for example, the angular velocity sensor element 11 included in the angular velocity sensor 10 has a high Q value and excellent temperature characteristics as a crystal element, whereas the angular velocity sensor element 23 included in each of the 6DoF sensors 20a and 20b is an element formed by using MEMS technology. Therefore, the detection accuracy of the Z-axis angular velocity of the angular velocity sensor 10 is higher than the detection accuracy of the Z-axis angular velocity of the 6DoF sensors 20a and 20b. Thus, the sampling processing portion 312 generates the measurement data DT by using the detection signal SD1 without using the Z-axis angular velocity detection signals included in the detection signals SD2a and SD2b, respectively.

Specifically, the sampling processing portion 312 performs various correction calculations such as temperature correction, sensitivity correction calculation, offset correction calculation, and alignment correction calculation, and filter processing on the detection signals SD1, SD2a, and SD2b. Further, the sampling processing portion 312 performs synthesis processing on the corrected detection signals SD2a and SD2b. That is, the sampling processing portion 312 combines the X-axis angular velocity detection signal included in the corrected detection signal SD2a and the X-axis angular velocity detection signal included in the corrected detection signal SD2b, and combines the Y-axis angular velocity detection signal included in the corrected detection signal SD2a and the Y-axis angular velocity detection signal included in the corrected detection signal SD2b. In addition, the sampling processing portion 312 combines the X-axis acceleration detection signal included in the corrected detection signal SD2a and the X-axis acceleration detection signal included in the corrected detection signal SD2b, combines the Y-axis acceleration detection signal included in the corrected detection signal SD2a and the Y-axis acceleration detection signal included in the corrected detection signal SD2b, and combines the Z-axis acceleration detection signal included in the corrected detection signal SD2a and the Z-axis acceleration detection signal included in the corrected detection signal SD2b. The synthesis processing may be, for example, averaging processing. By the synthesis processing, the random noise is reduced to 1/√2.

The sampling processing portion 312 generates the measurement data DT including the synthesized X-axis angular velocity detection signal, the synthesized Y-axis angular velocity detection signal, the Z-axis angular velocity detection signal which is the synthesized detection signal SD1, the synthesized X-axis acceleration detection signal, the synthesized Y-axis acceleration detection signal, and the synthesized Z-axis acceleration detection signal. In addition, the sampling processing portion 312 may perform known arithmetic processing on the three-axis angular velocity detection signals and the three-axis acceleration detection signals, and generate the measurement data DT including the position, the posture, the velocity, and the like of the sensor module 1.

Further, the sampling processing portion 312 generates the data ready signal DRDY for notifying that the measurement data DT is prepared each time the generation of the measurement data DT is completed, and outputs the data ready signal DRDY to the external device. The sampling processing portion 312 may output the data ready signal DRDY at a cycle shorter than the first time T1. In the present embodiment, the sampling processing portion 312 outputs the data ready signal DRDY after the third timer 32c ends the counting of the third time T3. Specifically, the sampling processing portion 312 outputs the data ready signal DRDY when the arithmetic processing for generating the measurement data DT is ended when the third timer 32c ends the counting of the third time T3. Further, the sampling processing portion 312 outputs the data ready signal DRDY after ending the arithmetic processing when the arithmetic processing for generating the measurement data DT is ended when the third timer 32c ends the counting of the third time T3.

The communication interface circuit 34 is a circuit that performs interface processing between the sensor module 1 and an external device (not illustrated). The communication interface circuit 34 outputs, for example, the measurement data DT generated by the processing portion 31 to the external device. The communication between the sensor module 1 and the external device may be performed in accordance with, for example, a communication standard such as SPI or I2C, or may be performed in accordance with a communication standard developed from any of these communication standards or a communication standard in which a part is improved or modified.

For example, the external device can write various setting data of the processing portion 31 to the register 333 or read various flag data stored in the register 333 via the communication interface circuit 34. Further, when the data ready signal DRDY is input, the external device transmits a read command for the measurement data DT to the sensor module 1 and can read the measurement data DT via the communication interface circuit 34.

### 1-2. Operation Timing of Sensor Module

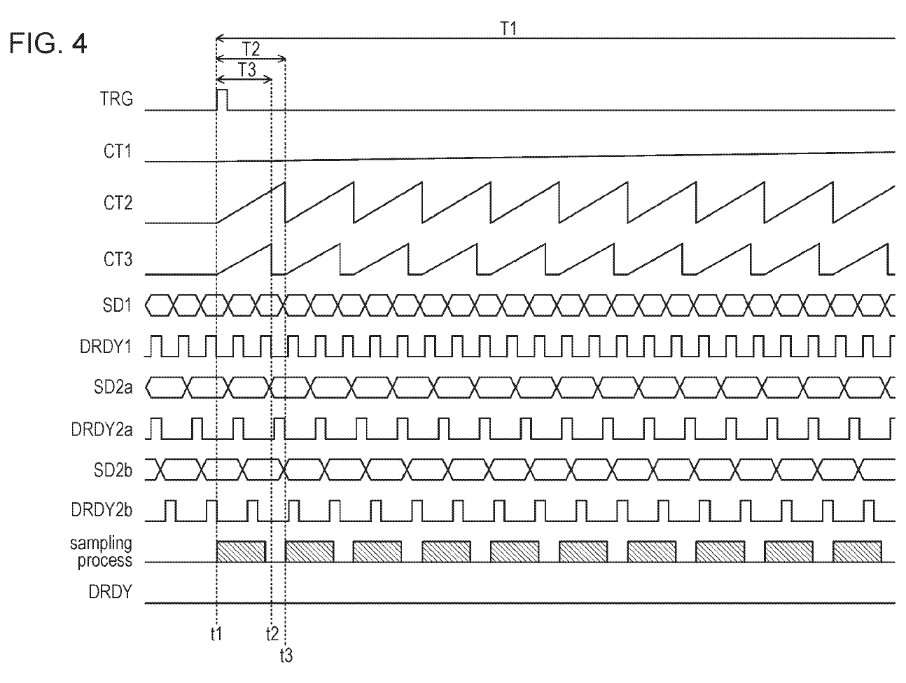

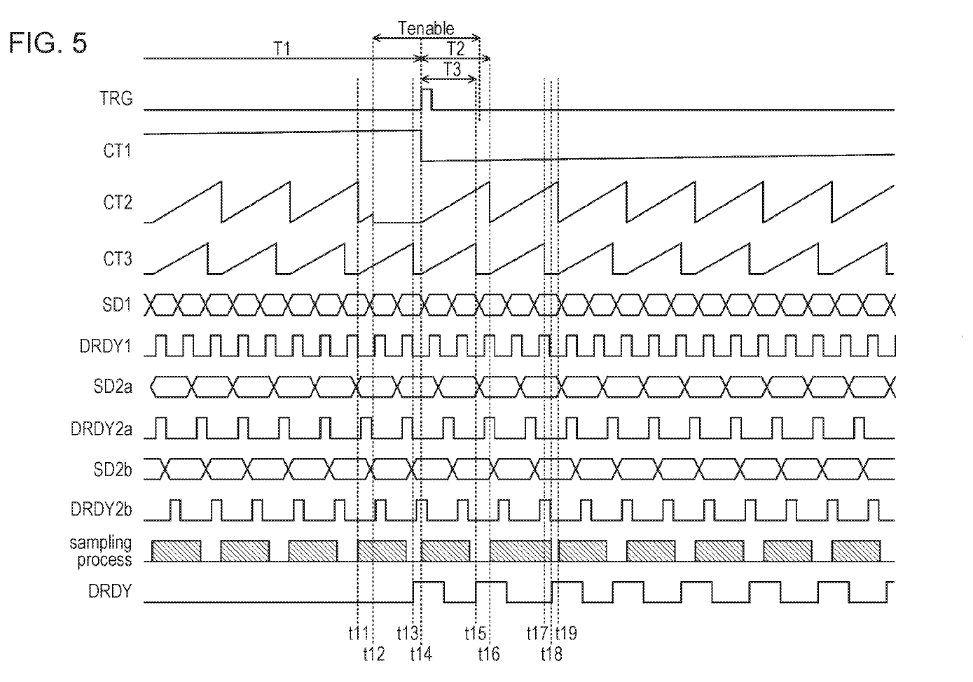

FIGS. 4 and 5 are timing chart diagrams illustrating an example of an operation of the sensor module 1. FIG. 4 is a timing chart diagram before and after the input of the first trigger signal TRG, and FIG. 5 is a timing chart diagram before and after the input of the second trigger signal TRG. In FIGS. 4 and 5, for example, the first time T1, which is the length of one cycle of the trigger signal TRG, is 1 second, the second time T2, which is the sampling cycle of the sampling processing portion 312, is 250 microseconds, and the third time T3 is 200 microseconds. In this case, when the cycle of the clock signal CLK is exactly 6.25 nanoseconds, the count value corresponding to the first time T1, which is 1 second, is 160000000, the count value corresponding to the second time T2, which is 250 microseconds, is 40000, and the count value corresponding to the third time T3 is 32000. Therefore, 40000, which is the count value corresponding to the second time T2, is set as the timeout value of the second timer 32b, and 32000, which is the count value corresponding to the third time T3, is set as the timeout value of the third timer 32c.

As illustrated in FIG. 4, when the first trigger signal TRG is input at time point t1, the first timer 32a, the second timer 32b, and the third timer 32c start counting. As a result, the count values CT1, CT2, and CT3 increase from 0 after time point t1.

Further, at time point t1, the sampling processing portion 312 starts the sampling processing. For example, the angular velocity sensor 10 outputs the data ready signal DRDY1 at a cycle of 100 microseconds, and the 6DoF sensors 20a and 20b output the data ready signals DRDY2a and DRDY2b at a cycle of 150 microseconds, respectively. The processing portion 31 acquires the detection signals SD1, SD2a, and SD2b each time the data ready signals DRDY1, DRDY2a, and DRDY2b are input, and stores the detection signals SD1, SD2a, and SD2b in the RAM 332 or the register 333. The sampling processing portion 312 samples the detection signals SD1, SD2a, and SD2b stored in the RAM 332 or the register 333, and starts the arithmetic processing. Therefore, the sampling processing portion 312 performs the arithmetic processing by sampling the detection signals SD1, SD2a, and SD2b at time point t1 or the detection signals SD1, SD2a, and SD2b immediately before the detection signals SD1, SD2a, and SD2b at time point t1.

Thereafter, at time point t2, the third timer 32c ends the counting of the third time point T3, and clears the count value CT3 to 0. At the time when the first trigger signal TRG is input, the count value of the first time T1 is unknown, and it is unknown whether or not the timeout value of the second timer 32b is appropriate. Therefore, the reliability of the measurement data DT generated by the sampling processing portion 312 is low. The third time T3 corresponds to the time from when the sampling processing portion 312 starts the sampling processing to when the data ready signal DRDY is output. However, the reliability of the measurement data DT is low until the second trigger signal TRG is input. Therefore, the sampling processing portion 312 does not output the data ready signal DRDY even when the third timer 32c ends the counting of the third time T3. That is, the data ready signal DRDY maintains the low level.

Thereafter, at time point t3, the second timer 32b ends the counting of the second time T2, and clears the count value CT2 to zero. At time point t3, the second timer 32b and the third timer 32c start the next counting, and the sampling processing portion 312 starts the next sampling processing.

After time point t3, the sensor module 1 repeats the same operation as the period of time point t1 to time point t3.

As illustrated in FIG. 5, thereafter, at time point t11, the second timer 32b ends the counting of the second time T2, and clears the count value CT2 to zero. The period from time point t11 to time point t13 corresponds to the period of the sampling processing immediately before the second trigger signal TRG is input. Time point t13 at which the period ends is the time point at which the second trigger signal TRG is input for the second time, and the second timer 32b does not count the second time T2. Therefore, the second timer 32b is used for counting the time until the input allowable period Tenable for the next trigger signal TRG starts, and the second timer 32b starts counting at time point t11. For example, the time until the input allowable period Tenable starts is 50 microseconds, and 8000, which is the count value corresponding to 50 microseconds, is set as the timeout value of the second timer 32b.

After that, at time point t12, the second timer 32b ends the counting of the time until the input allowable period Tenable starts, and clears the count value CT2 to zero. The length of the input allowable period Tenable is set to, for example, 400 microseconds.

After that, at time point t13, the third timer 32c ends the counting of the third time T3, and clears the count value CT3 to 0. Further, the sampling processing portion 312 outputs the data ready signal DRDY.

After that, the second trigger signal TRG is input at time point t14 included in the input allowable period Tenable, the first timer 32a ends the counting of the first time T1, and clears the count value CT1 to zero. The count value CT1 of the first time T1 is a count value corresponding to the length of one cycle of the trigger signal TRG, and the trigger processing portion 311 calculates the timeout value of the second time T2 from the count value CT1. Specifically, the trigger processing portion 311 calculates the timeout value for the second time T2 by dividing the count value CT1 for the first time T1 by the number of times the sampling processing portion 312 performs the sampling processing in the first time T1. For example, the trigger processing portion 311 divides the count value CT1 in the first time T1 by 4000 to calculate the timeout value in the second time T2 when the sampling processing portion 312 performs the sampling processing 4000 times during one cycle of the trigger signal TRG.

In addition, at time point t14, the first timer 32a, the second timer 32b, and the third timer 32c start counting. As a result, the count values CT1, CT2, and CT3 increase from 0 after time point t13.

The trigger processing portion 311 ignores the trigger signal TRG and outputs an error signal when the next trigger signal TRG is input in a period other than the input allowable period Tenable. This error signal is stored in the register 333 as an error flag, and the external device can recognize the occurrence of an error by reading the error flag.

Thereafter, at time point t15, the third timer 32c ends the counting of the third time T3, and clears the count value CT3 to 0. Further, since the sampling processing portion 312 ends the sampling processing at time point t15 at which the third timer 32c ends the counting of the third time T3, the sampling processing portion 312 outputs the data ready signal DRDY.

Thereafter, at time point t16, the second timer 32b ends the counting of the second time T2, and clears the count value CT2 to zero. At time point t16, the second timer 32b and the third timer 32c start the next counting, and the sampling processing portion 312 starts the next sampling processing.

Thereafter, at time point t17, the third timer 32c ends the counting of the third time T3, and clears the count value CT3 to 0. Since the sampling processing portion 312 has not ended the sampling processing at time point t15 at which the third timer 32c ends the counting of the third time T3, the sampling processing portion 312 does not output the data ready signal DRDY. For example, when the processing portion 31 gives priority to the processing other than the sampling processing such as the interrupt processing, the end of the sampling processing may be delayed.

Thereafter, at time point t18, the sampling processing portion 312 ends the sampling processing, and outputs the data ready signal DRDY. As described above, the sampling processing portion 312 does not end the sampling processing at time point t17 at which the third timer 32c ends the counting of the third time T3. Thus, the sampling processing portion 312 does not output the data ready signal DRDY, and outputs the data ready signal DRDY after the sampling processing is ended.

Thereafter, at time point t19, the second timer 32b ends the counting of the second time T2, and clears the count value CT2 to zero. In addition, at time point t19, the second timer 32b and the third timer 32c start the next counting, and the sampling processing portion 312 starts the next sampling processing.

After time point t19, the sensor module 1 repeats the same operation as the period from time point t14 to time point t16 or the period from time point t16 to time point t19.

### 1-3. Setting Processing of Sampling Cycle

As described with reference to FIG. 5, the trigger processing portion 311 calculates the timeout value for the second time T2 by dividing the count value CT1 for the first time T1 by the number of times the sampling processing portion 312 performs the sampling processing in the first time T1. When the division value is an integer, the division value can be set as the timeout value. However, when the division value is not an integer, when the division value is set as the timeout value, the decimal part of the division value becomes an error, and the measurement accuracy is lowered. Therefore, when the division value is not an integer, in the first time T1, the timeout value of the second timer 32b in each sampling cycle is changed, and the average value of the timeout is adjusted to be equal to the division value. That is, the trigger processing portion 311 adjusts the timeout value of the second timer 32b based on the value obtained by dividing by the number of times the sampling processing portion 312 performs the sampling processing in the first time T1.

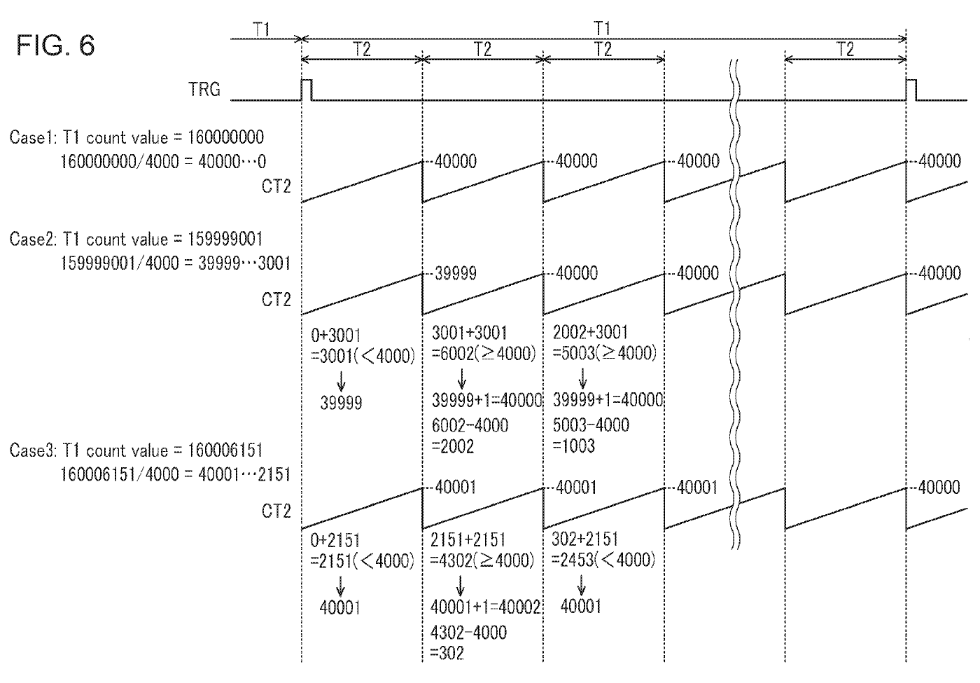

For example, when the first time T1 is 1 second and the second time T2 is 250 microseconds, as illustrated in FIG. 6, when the count value CT1 of the first time T1 is 160000000, the count value CT2 of the second time T2 is 160000000/4000 = 40000. In this case, the timeout value of the second timer 32b is constant at 40000.

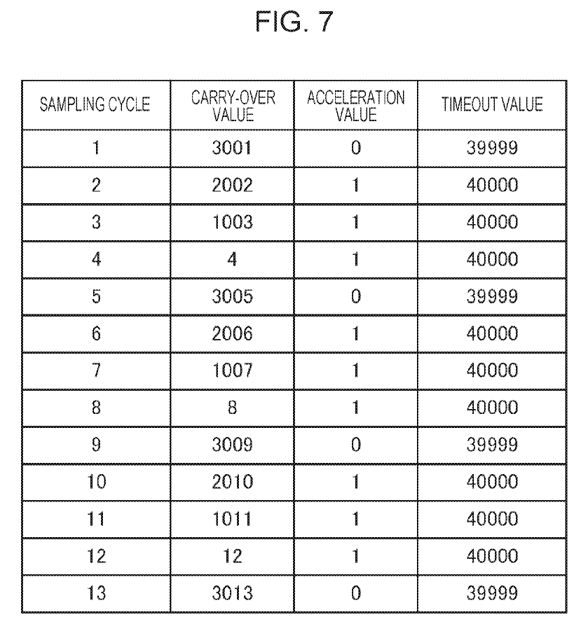

On the other hand, when the count value CT1 of the first time T1 is 159999001, the count value CT1 becomes 159999001/4000 = 39999 ... 3001. Since the remainder 3001 is less than 4000, the timeout value of the first sampling cycle becomes 39999. 3001 is carried over, and the remainder 3001 is added to 3001, resulting in 3001 + 3001 = 6002 ≥ 4000, and thus the timeout value of the second sampling cycle becomes 39999 + 1 = 40000. 6002 - 4000 = 2002 is carried over, and the remainder 3001 is added to 2002, resulting in 2002 + 3001 = 5003 ≥ 4000, and thus the timeout value of the third sampling cycle becomes 39999 + 1 = 40000. FIG. 7 illustrates a sequence of timeout values of the second timer 32b up to the thirteenth sampling cycle. As illustrated in FIG. 7, the timeout value for each sampling cycle is 39999 or 40000.

As illustrated in FIG. 6, when the count value CT1 for the first time T1 is 160006151, the count value CT1 becomes 160006151/4000 = 40001...2151. Since the remainder 2151 is less than 4000, the timeout value of the first sampling cycle becomes 40001. 2151 is carried over, and the remainder 2151 is added to 2151, resulting in 2151 + 2151 = 4302 ≥ 4000, and thus the timeout value of the second sampling cycle becomes 40001 + 1 = 40002. 4302 - 4000 = 302 is carried over, and the remainder 2151 is added to 302, resulting in 302 + 2151 = 2453 < 4000, and thus the timeout value of the third sampling cycle becomes 40001. As described above, the timeout value for each sampling cycle is 40001 or 40002.

### 1-4. Operational Effect

As described above, in the sensor module 1 of the first embodiment, the trigger processing portion 311 generates the timing signal TMG having a cycle shorter than the cycle of the trigger signal TRG in synchronization with the trigger signal TRG input from the outside of the sensor module 1, and the sampling processing portion 312 performs the arithmetic processing by sampling the detection signals SD1, SD2a, and SD2b output from the angular velocity sensor 10 and the 6DoF sensors 20a and 20b, respectively, based on the timing signal TMG, and outputs the data ready signal DRDY. Therefore, according to the sensor module 1 of the first embodiment, the measurement data DT and the data ready signal DRDY obtained by the arithmetic processing can be output at a cycle shorter than the cycle of the trigger signal TRG in synchronization with the trigger signal TRG.

In addition, according to the sensor module 1 of the first embodiment, the timeout value of the second timer 32b is adjusted based on the value obtained by dividing the count value in the first time T1 by the number of times the sampling processing portion 312 performs the arithmetic processing in the first time T1. Therefore, even when the division value is not an integer multiple, the measurement data DT can be output in synchronization with the trigger signal TRG.

In addition, according to the sensor module 1 of the first embodiment, the data ready signal DRDY can be repeatedly output at a constant timing by outputting the data ready signal DRDY after the third timer 32c ends the counting of the third time T3. In particular, according to the sensor module 1 of the first embodiment, when the third timer 32c ends the counting of the third time T3, the sampling processing portion 312 outputs the data ready signal DRDY when the arithmetic processing is ended. Therefore, the data ready signal DRDY can be repeatedly output at a constant timing when the third timer 32c ends the counting of the third time T3. In addition, according to the sensor module 1 of the first embodiment, when the third timer 32c ends the counting of the third time T3, when the sampling processing portion 312 does not end the arithmetic processing, the data ready signal DRDY is output after the arithmetic processing is ended. Therefore, even when the arithmetic processing is delayed, the data ready signal DRDY can be output at the timing when the arithmetic processing is ended.

In addition, according to the sensor module 1 of the first embodiment, when the next trigger signal TRG is input in the period that is not the input allowable period, the trigger processing portion 311 ignores the trigger signal TRG and outputs the error signal. Therefore, the possibility of malfunction when the erroneous trigger signal TRG is input due to the influence of noise or the like is reduced, and the external device can recognize that the erroneous trigger signal TRG is input.

### 2. Second Embodiment

In the following, for a second embodiment, components similar to those in the first embodiment will be given the same symbols, and the descriptions that overlap with the first embodiment will be omitted or simplified, and the differences from the first embodiment will be mainly described.

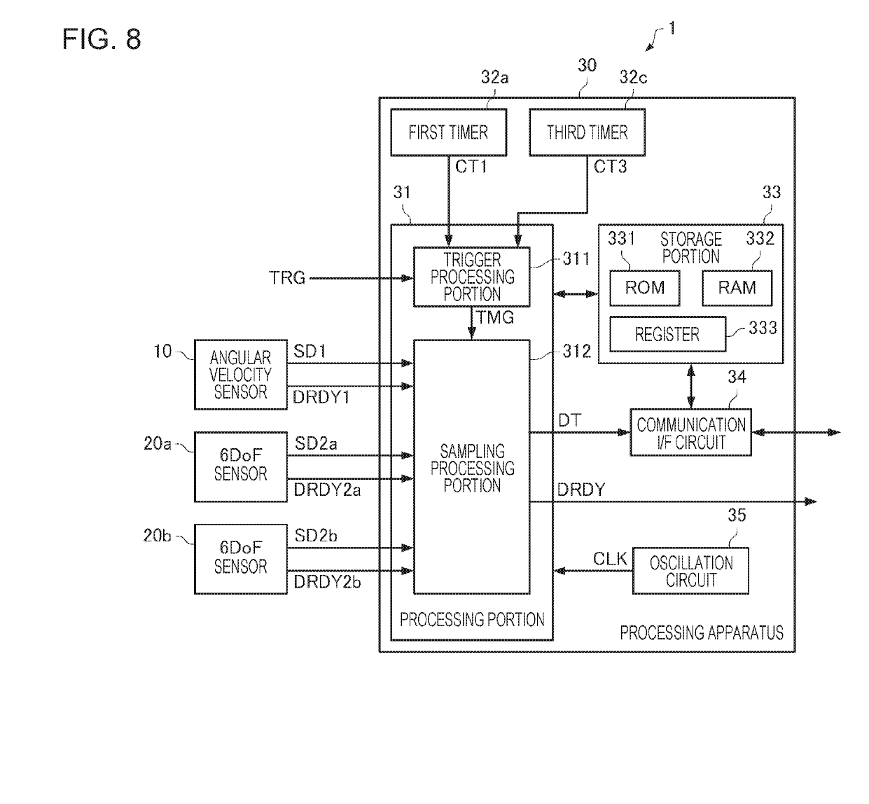

FIG. 8 is a diagram illustrating a configuration of the sensor module 1 of the second embodiment. As illustrated in FIG. 8, the sensor module 1 of the second embodiment is different from the first embodiment in that the processing apparatus 30 does not include the second timer 32b and the trigger processing portion 311 generates the timing signal TMG based on the count value of the first timer 32a.

Also in the second embodiment, similar to the first embodiment, the trigger processing portion 311 determines the second time T2 based on the count value CT1 of the first time T1 counted by the first timer 32a, and generates the timing signal TMG each time the second time T2 elapses in synchronization with the trigger signal TRG. However, in the second embodiment, the trigger processing portion 311 generates the timing signal TMG each time the count value CT1 of the first timer 32a changes by a value corresponding to the second time T2, and outputs the timing signal TMG to the sampling processing portion 312.

Specifically, the trigger processing portion 311 calculates the value corresponding to the second time T2 by dividing the count value CT1 for the first time T1 by the number of times the sampling processing portion 312 performs the sampling processing in the first time T1. When the division value is an integer, the trigger processing portion 311 can generate the timing signal TMG each time the division value changes. However, when the division value is not an integer, when the trigger processing portion 311 generates the timing signal TMG each time the division value changes by that amount, the decimal part of the division value becomes an error, and the measurement accuracy is lowered. Therefore, when the division value is not an integer, the value corresponding to the second time T2 in each sampling cycle changes in the first time T1, and the average value of the value corresponding to the second time T2 is adjusted to be equal to the division value. That is, the trigger processing portion 311 adjusts the value corresponding to the second time T2 based on the value obtained by dividing by the number of times the sampling processing portion 312 performs the sampling processing in the first time T1.

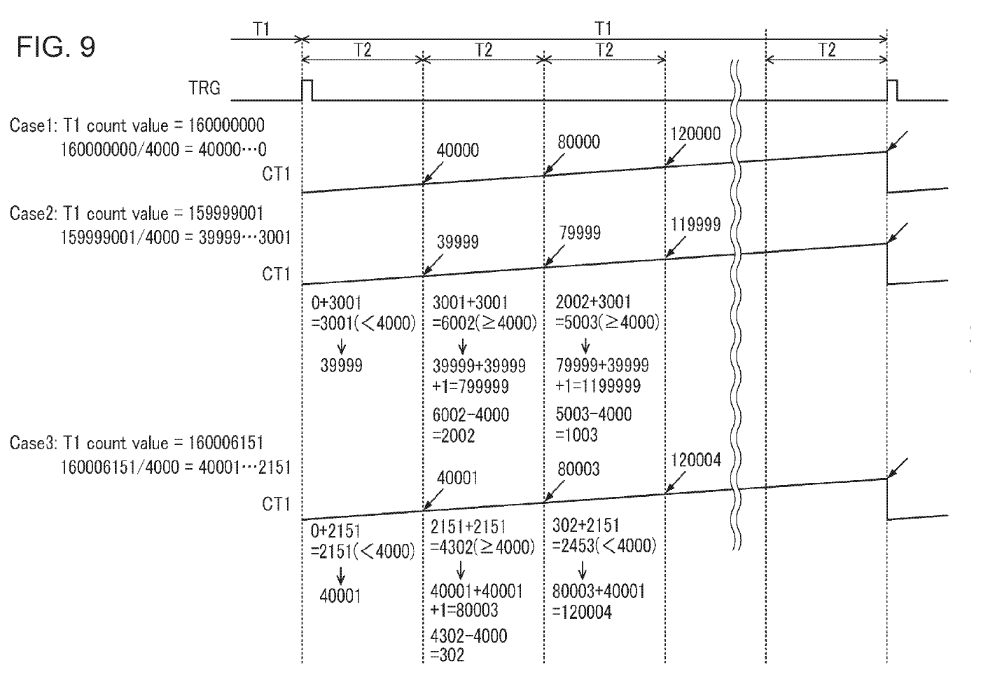

For example, when the first time T1 is 1 second and the second time T2 is 250 microseconds, as illustrated in FIG. 9, when the count value CT1 of the first time T1 is 160000000, the value corresponding to the second time T2 is 160000000/4000 = 40000. In this case, the value corresponding to the second time T2 is constant at 40000.

On the other hand, when the count value CT1 of the first time T1 is 159999001, the count value CT1 becomes 159999001/4000 = 39999 ... 3001. Since the remainder 3001 is less than 4000, the value corresponding to the second time in the first sampling cycle becomes 39999. Therefore, the trigger processing portion 311 generates the timing signal TMG when the count value CT1 of the first timer 32a changes only from 0 to 39999. 3001 is carried over, and the remainder 3001 is added to 3001, resulting in 3001 + 3001 = 6002 ≥ 4000, and thus the value corresponding to the second time in the second sampling cycle becomes 39999 + 1 = 40000. Therefore, the trigger processing portion 311 generates the timing signal TMG when the count value CT1 of the first timer 32a changes from 39999 to 79999 by only 40000. 6002 - 4000 = 2002 is carried over, and the remainder 3001 is added to 2002, resulting in 2002 + 3001 = 5003 ≥ 4000, and thus the value corresponding to the second time in the third sampling cycle becomes 39999 + 1 = 40000. Therefore, the trigger processing portion 311 generates the timing signal TMG when the count value CT1 of the first timer 32a changes from 79999 to 119999 by only 40000.

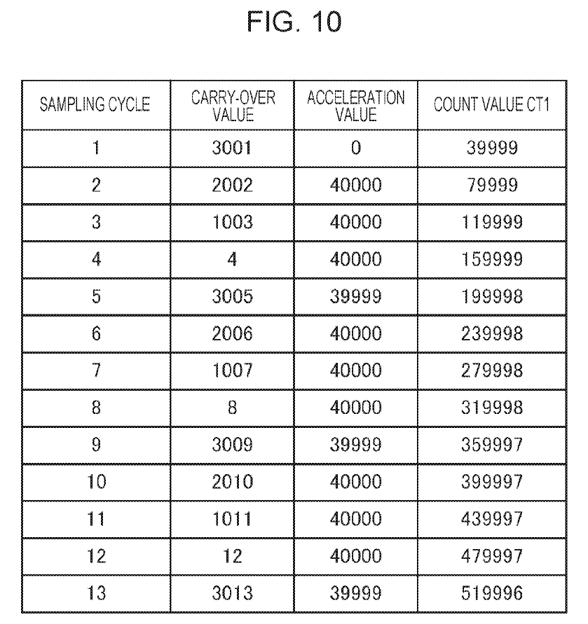

FIG. 10 illustrates a sequence of values corresponding to the second time up to the thirteenth sampling cycle. As illustrated in FIG. 10, the value corresponding to the second time in each sampling cycle is 39999 or 40000, and the trigger processing portion 311 generates the timing signal TMG each time the count value CT1 changes by 39999 or 40000.

As illustrated in FIG. 9, when the count value CT1 for the first time T1 is 160006151, the count value CT1 becomes 160006151/4000 = 40001...2151. Since the remainder 2151 is less than 4000, the value corresponding to the second time in the first sampling cycle becomes 40001. Therefore, the trigger processing portion 311 generates the timing signal TMG when the count value CT1 of the first timer 32a changes only from 0 to 40001. 2151 is carried over, and the remainder 2151 is added to 2151, resulting in 2151 + 2151 = 4302 ≥ 4000, and thus the value corresponding to the second time in the second sampling cycle becomes 40001 + 1 = 40002. Therefore, the trigger processing portion 311 generates the timing signal TMG when the count value CT1 of the first timer 32a changes from 40001 to 80003 by only 40002. 4302 - 4000 = 302 is carried over, and the remainder 2151 is added to 302, resulting in 302 + 2151 = 2453 < 4000, and thus the value corresponding to the second time in the third sampling cycle becomes 40001. Therefore, the trigger processing portion 311 generates the timing signal TMG when the count value CT1 of the first timer 32a changes from 80003 to 120004 by only 40001. As described above, the value corresponding to the second time in each sampling cycle is 40001 or 40002, and the trigger processing portion 311 generates the timing signal TMG each time the count value CT1 changes by 40001 or 40002.

Since other configurations of the sensor module 1 of the second embodiment are the same as those of the sensor module 1 of the first embodiment, the description thereof will be omitted.

According to the sensor module 1 of the second embodiment described above, the same effects as those of the sensor module 1 of the first embodiment can be obtained. Further, according to the sensor module 1 of the second embodiment, the processing apparatus 30 does not need the second timer 32b, and thus the processing apparatus 30 can be reduced in size and cost.

### 3. Modification Examples

The present disclosure is not limited to the present embodiment, and various modifications may be made without departing from the scope of the present disclosure.

For example, the sensor module 1 of the above embodiment includes the three sensor devices, that is, the angular velocity sensor 10, and the 6DoF sensors 20a and 20b, but the number of sensor devices included in the sensor module 1 may be one, two, or four or more. In addition, the sensor device included in the sensor module 1 may not be the angular velocity sensor or the 6DoF sensor, and may be, for example, a sensor that detects acceleration, angular acceleration, velocity, or the like.

### 4. Application Example

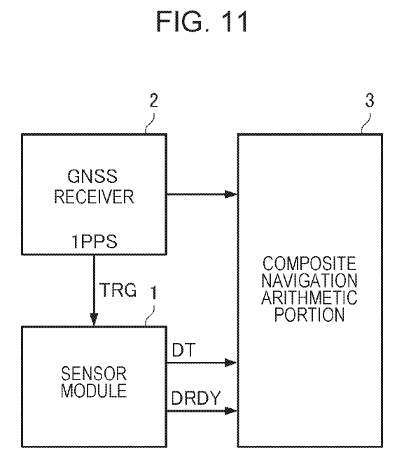

The sensor module 1 of the present embodiment can be used in, for example, a composite navigation system using a global navigation satellite system (GNSS) and an inertial navigation system (INS). FIG. 11 illustrates an example of a composite navigation system in which the sensor module 1 illustrated in FIGS. 1 or 8 is incorporated. The composite navigation system illustrated in FIG. 11 includes the sensor module 1, a GNSS receiver 2, and a composite navigation arithmetic portion 3, and is mounted on a moving object such as an automobile.

The GNSS receiver 2 receives satellite signals transmitted from a plurality of satellites that configure a part of the GNSS via an antenna (not illustrated) respectively, performs positioning based on the received satellite signals, and outputs data such as a position, a velocity, and an azimuth to the composite navigation arithmetic portion 3. Further, the GNSS receiver 2 outputs a 1PPS signal to the sensor module 1. Examples of the GNSS include a global positioning system (GPS), a quasi zenith satellite system (QZSS), a European geostationary navigation overlay service (EGNOS), a global navigation satellite system (GLONASS), GALILEO, and BeiDou.

The sensor module 1 receives the 1PPS signal output from the GNSS receiver 2 as the trigger signal TRG, and outputs the data ready signal DRDY having a cycle shorter than the cycle of the trigger signal TRG to the composite navigation arithmetic portion 3.

The composite navigation arithmetic portion 3 acquires the measurement data DT generated by the sensor module 1 for each input of the data ready signal DRDY. The composite navigation arithmetic portion 3 performs a composite navigation arithmetic processing using the measurement data DT and data output from the GNSS receiver 2, and calculates the position, the velocity, the posture, the azimuth, and the like of the moving object.

The above-described embodiments and modification examples are merely examples, and the present disclosure is not limited thereto. For example, the respective embodiments and the respective modification examples can be combined as appropriate.

The present disclosure includes a configuration substantially the same as the configuration described in the embodiment, for example, a configuration having the same function, method, and result, or a configuration having the same purpose and effect. In addition, the present disclosure includes configurations in which non-essential parts of the configuration described in the embodiments are replaced. In addition, the present disclosure includes configurations that achieve the same effects or configurations that can achieve the same objects as those of the configurations described in the embodiment. In addition, the present disclosure includes configurations in which a publicly known technology is added to the configurations described in the embodiments.

The following contents are derived from the above-described embodiments and modification examples.

According to an aspect of the present disclosure, there is provided a sensor module including: a sensor device; a first timer that counts a first time which is a time of one cycle of a trigger signal input from an outside; a trigger processing portion that determines a second time shorter than the first time based on a count value of the first time counted by the first timer, and generates a timing signal each time the second time elapses in synchronization with the trigger signal; and a sampling processing portion that performs arithmetic processing by sampling a signal output from the sensor device in synchronization with the timing signal.

The sensor module, in synchronization with the trigger signal input from the outside, generates a timing signal having a cycle shorter than a cycle of the trigger signal, and performs the arithmetic processing by sampling the signal output from the sensor device based on the timing signal. Therefore, according to the sensor module, the data obtained by the arithmetic processing can be output at a cycle shorter than the cycle of the trigger signal in synchronization with the trigger signal.

In the sensor module according to the aspect, a second timer that repeatedly counts the second time in synchronization with the trigger signal, may be further provided, and the trigger processing portion may generate the timing signal each time the second timer counts the second time.

In the sensor module according to the aspect, the trigger processing portion may adjust a timeout value of the second timer based on a value obtained by dividing the count value of the first time counted by the first timer by the number of times the sampling processing portion performs the arithmetic processing in the first time.

According to the sensor module, even when the time of one cycle of the trigger signal is not an integer multiple of the number of times the sampling processing portion performs the arithmetic processing during one cycle of the trigger signal, the data can be output in synchronization with the trigger signal.

In the sensor module according to the aspect, the trigger processing portion may generate the timing signal each time the count value of the first timer changes by a value corresponding to the second time.

In the sensor module according to the aspect, the trigger processing portion may adjust the value corresponding to the second time based on a value obtained by dividing the count value of the first time counted by the first timer by the number of times the sampling processing portion performs the arithmetic processing in the first time.

According to the sensor module, even when the time of one cycle of the trigger signal is not an integer multiple of the number of times the sampling processing portion performs the arithmetic processing during one cycle of the trigger signal, the data can be output in synchronization with the trigger signal.

In the sensor module according to the aspect, a third timer that counts a third time shorter than the second time in synchronization with the timing signal, may be further provided, and the sampling processing portion may output a data ready signal after the third timer ends the counting of the third time.

According to this sensor module, the data ready signal can be repeatedly output at a constant timing.

In the sensor module according to the aspect, the sampling processing portion may output the data ready signal when the arithmetic processing is ended when the third timer ends the counting of the third time.

According to this sensor module, the data ready signal can be repeatedly output at a certain timing when the third timer ends the counting of the third time.

In the sensor module according to the aspect, the sampling processing portion may output the data ready signal after the sampling processing portion ends the arithmetic processing when the arithmetic processing is not ended when the third timer ends the counting of the third time.

According to this sensor module, the data ready signal can be output at the timing when the arithmetic processing is ended even when the timing at which the arithmetic processing is ended is later than the timing at which the third timer ends the counting of the third time.

In the sensor module according to the aspect, the trigger processing portion may ignore the trigger signal and output an error signal when the next trigger signal is input in a period that is not an input allowable period.

According to the sensor module, the possibility of malfunction when an erroneous trigger signal is input due to the influence of noise or the like is reduced, and the external device can recognize that the erroneous trigger signal is input.

In the sensor module according to the aspect, the sampling processing portion may output the data ready signal in a cycle shorter than the first time.

According to the sensor module, the data and the data ready signal obtained by the arithmetic processing can be output at a cycle shorter than the cycle of the trigger signal in synchronization with the trigger signal.

What is claimed is:

1. A sensor module comprising:
a sensor device;
a first timer that counts a first time which is a time of one cycle of a trigger signal input from an outside;
a trigger processing portion that determines a second time shorter than the first time based on a count value of the first time counted by the first timer, and generates a timing signal each time the second time elapses in synchronization with the trigger signal; and
a sampling processing portion that performs arithmetic processing by sampling a signal output from the sensor device in synchronization with the timing signal.

2. The sensor module according to claim 1, further comprising:
a second timer that repeatedly counts the second time in synchronization with the trigger signal, wherein
the trigger processing portion generates the timing signal each time the second timer counts the second time.

3. The sensor module according to claim 2, wherein
the trigger processing portion adjusts a timeout value of the second timer based on a value obtained by dividing the count value of the first time counted by the first timer by the number of times the sampling processing portion performs the arithmetic processing in the first time.

4. The sensor module according to claim 1, wherein
the trigger processing portion generates the timing signal each time the count value of the first timer changes by a value corresponding to the second time.

5. The sensor module according to claim 4, wherein
the trigger processing portion adjusts the value corresponding to the second time based on a value obtained by dividing the count value of the first time counted by the first timer by the number of times the sampling processing portion performs the arithmetic processing in the first time.

6. The sensor module according to claim 1, further comprising:
a third timer that counts a third time shorter than the second time in synchronization with the timing signal, wherein
the sampling processing portion outputs a data ready signal after the third timer ends the counting of the third time.

7. The sensor module according to claim 6, wherein
the sampling processing portion outputs the data ready signal when the sampling processing portion ends the arithmetic processing when the third timer ends the counting of the third time.

8. The sensor module according to claim 6, wherein
the sampling processing portion outputs the data ready signal after the sampling processing portion ends the arithmetic processing when the arithmetic processing is not ended when the third timer ends the counting of the third time.

9. The sensor module according to claim 1, wherein
the trigger processing portion ignores the trigger signal and outputs an error signal when the next trigger signal is input in a period that is not an input allowable period.

10. The sensor module according to claim 1, wherein
the sampling processing portion outputs a data ready signal in a cycle shorter than the first time.
